(19) United States
(12) Patent Application Publication
(10) Pub. No.: US 2013/0241784 A1
(43) Pub. Date: Sep. 19, 2013

(54) COMMUNICATION DEVICE AND TUNABLE ANTENNA ELEMENT THEREIN

(71) Applicants: Kin-Lu WONG, Kaohsiung City (TW); Yi-Ting HSIEH, Kaohsiung City (TW)

(72) Inventors: Kin-Lu WONG, Kaohsiung City (TW); Yi-Ting HSIEH, Kaohsiung City (TW)

(73) Assignee: Acer Incorporated, Taipei Hsien (TW)

(21) Appl. No.: 13/454,988

(22) Filed: Apr. 24, 2012

(30) Foreign Application Priority Data
Mar. 14, 2012 (TW) 101108578

(51) Int. Cl. H01Q 9/00

(52) U.S. Cl. 343/749

(57) ABSTRACT

A communication device includes a ground element, an antenna element, a circuit element group, and a communication module. The antenna element is a loop antenna. One end of the antenna element is a grounding end coupled to the ground element, and the other end of the antenna element is a feeding end close to the grounding end. The circuit element group includes at least two separate circuit element sub-groups. The communication module is coupled to the circuit element group. One of the circuit element sub-groups of the circuit element group is selectively coupled to the feeding end so as to make the antenna element operate in different communication bands.

### CROSS REFERENCE TO RELATED APPLICATIONS

This Application claims priority of Taiwan Patent Application No. 101108578 filed on Mar. 14, 2012, the entirety of which is incorporated by reference herein.

### BACKGROUND OF THE INVENTION

1. Field of the Invention

The disclosure generally relates to a communication device, and more particularly, relates to a communication device and a tunable antenna element therein.

2. Description of the Related Art

With progress in mobile communication technology, the users use communication devices not only for talking but also for a variety of requirements. In order to meet the requirements using slim and small-size communication devices, the limited space for the internal antennas in the communication devices is very valuable. As a matter of fact, it is important to effectively use the limited space for the internal antennas in the communication devices.

Therefore, there is a need for an antenna element of a mobile communication device to operate in different communication bands by switching to different circuit elements without changing the size and the structure of the antenna element in the mobile communication device. The antenna element should have more operating bands without increasing the space for antenna design.

### BRIEF SUMMARY OF THE INVENTION

The invention provides a communication device and a tunable antenna element therein. The communication device comprises an antenna element which is a loop antenna, and the communication device selectively electrically couples one of at least two separate circuit element sub-groups to a feeding end of the antenna element. Therefore, the antenna element can operate in different communication bands, covering WWAN/LTE bands.

In one exemplary embodiment, the disclosure is directed to a communication device, comprising: a ground element; an antenna element, wherein the antenna element is a loop antenna, one end of the antenna element is a grounding end coupled to the ground element, and the other end of the antenna element is a feeding end close to the grounding end; a circuit element group comprising at least two separate circuit element sub-groups; and a communication module coupled to the circuit element group, wherein one of the circuit element sub-groups of the circuit element group is selectively coupled to the feeding end so as to make the antenna element operate in different communication bands.

In the invention, the antenna element is a loop antenna, and each circuit element sub-group of the circuit element group may comprise at least a capacitive element and an inductive element that are electrically coupled in series. Note that each circuit element sub-group has different capacitances of the capacitive element and different inductances of the inductive element. By a selection circuit, when the antenna element is electrically coupled to one of these circuit element sub-groups, different capacitances and inductances can correspond to multiple communication bands for optimal impedance matching, thereby making the antenna element operate in multiple communication bands. The communication device with the loop antenna is capable of covering different communication bands (e.g., WWAN/LTE bands) by electrically coupling to different capacitive and inductive elements in series without changing the size of the antenna element. In an embodiment, the antenna element has a feeding end which is close to a grounding end, and the antenna element substantially has an inverted L-shape or an L-shape. This antenna structure can lead to easy adjustment of the frequency ratio of higher-order resonant modes to a fundamental (lowest frequency) resonant mode of the antenna element so as to cover dual bands or multiple bands of mobile communications.

### BRIEF DESCRIPTION OF DRAWINGS

The invention can be more fully understood by reading the subsequent detailed description and examples with references made to the accompanying drawings, wherein:

FIG. 1A is a diagram for illustrating a communication device according to a first embodiment of the invention;

FIG. 1B is a diagram for illustrating a communication device according to another embodiment of the invention;

FIG. 2 is a diagram for illustrating a communication device according to a second embodiment of the invention;

FIG. 3 is a diagram for illustrating return loss when an antenna element is electrically coupled through a selection circuit to a first circuit element sub-group according to the second embodiment of the invention;

FIG. 4 is a diagram for illustrating antenna efficiency when the antenna element is electrically coupled through the selection circuit to the first circuit element sub-group according to the second embodiment of the invention;

FIG. 5 is a diagram for illustrating return loss when the antenna element is electrically coupled through the selection circuit to a second circuit element sub-group according to the second embodiment of the invention;

FIG. 6 is a diagram for illustrating antenna efficiency when the antenna element is electrically coupled through the selection circuit to the second circuit element sub-group according to the second embodiment of the invention;

FIG. 7 is a diagram for illustrating return loss when the antenna element is electrically coupled through the selection circuit to a third circuit element sub-group according to the second embodiment of the invention; and

FIG. 8 is a diagram for illustrating antenna efficiency when the antenna element is electrically coupled through the selection circuit to the third circuit element sub-group according to the second embodiment of the invention.

### DETAILED DESCRIPTION OF THE INVENTION

In order to illustrate the foregoing and other purposes, features and advantages of the invention, the embodiments and figures thereof in the invention are shown in detail as follows.

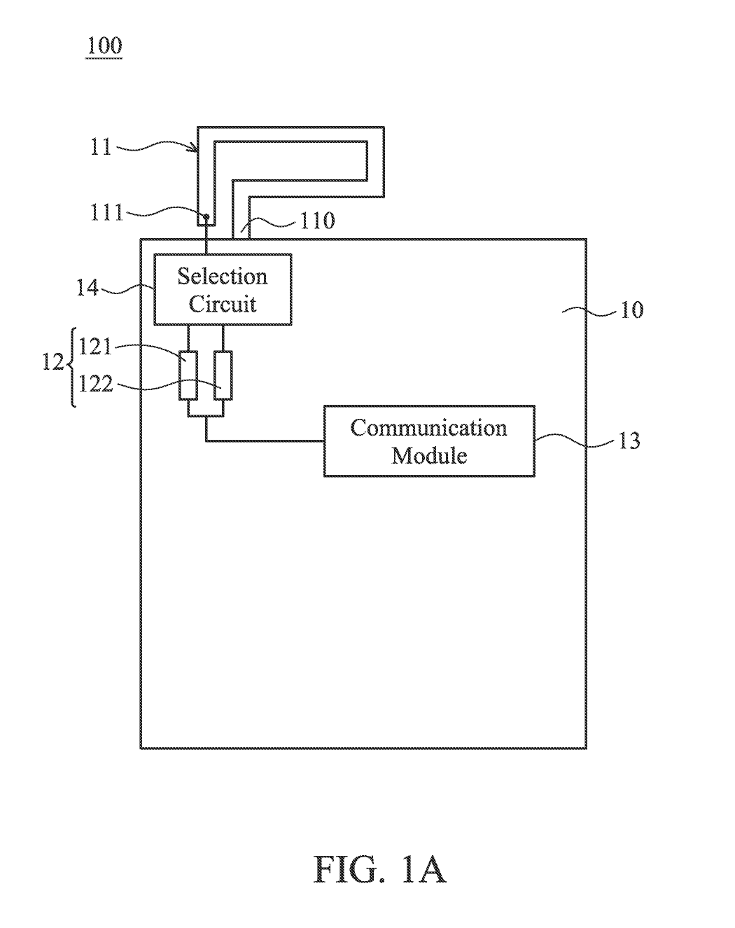

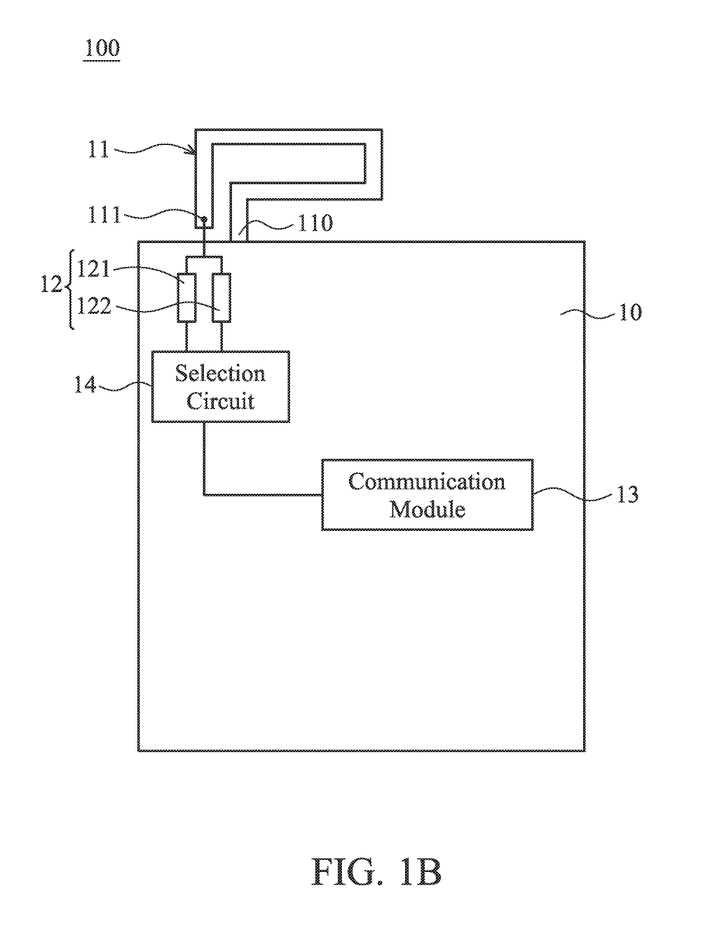

FIG. 1A is a diagram for illustrating a communication device 100 according to a first embodiment of the invention. As shown in FIG. 1A, the communication device 100 comprises a ground element 10, an antenna element 11, a circuit element group 12, and a communication module 13. The antenna element 11 is a loop antenna. One end of the antenna element 11 is a grounding end 110 which is electrically coupled to the ground element 10, and the other end of the antenna element 11 is a feeding end 111 which is close to the grounding end 110. In a preferred embodiment, the antenna element 11 substantially has an inverted L-shape or an L-shape. In other embodiments, the antenna element 11 may have other shapes, such as a C-shape, a U-shape, or an I-shape. The circuit element group 12 comprises two separate circuit element sub-groups, that is, a first circuit element sub-group 121 and a second circuit element sub-group 122. The communication module 13 is electrically coupled to the circuit element group 12. Either the first circuit element sub-group 121 or the second circuit element sub-group 122 is electrically coupled through a selection circuit 14 to the feeding end 111 of the antenna element 11 so as to make the antenna element 11 operate in different communication bands. Each of the first circuit element sub-group 121 and the second circuit element sub-group 122 comprises at least an inductive element (e.g., a chip inductor) and a capacitive element (e.g., a chip capacitor), wherein the inductive element and the capacitive element are electrically coupled in series. In some embodiments, the selection circuit 14 is electrically coupled to either the first circuit element sub-group 121 or the second circuit element sub-group 122 according to a user input or a control signal generated by a processor (not shown). Note that the first circuit element sub-group 121 and the second circuit element sub-group 122 have different capacitances of the capacitive elements and different inductances of the inductive elements. The capacitive elements are configured to adjust a low-frequency band of the antenna element 11, and the inductive elements are configured to adjust a high-frequency band of the antenna element 11. When the feeding end 111 is electrically coupled to the first circuit element sub-group 121, the antenna element 11 operates in a first band and a second band. When the feeding end 111 is electrically coupled to the second circuit element sub-group 122, the antenna element 11 operates in a third band and a fourth band. Each of the first band, the second band, the third band and the fourth band covers at least one mobile communication band.

FIG. 1B is a diagram for illustrating a communication device 100 according to another embodiment of the invention. As shown in FIG. 1B, the selection circuit 14 may be electrically coupled between the circuit element group 12 and the communication module 13 instead, and the selection circuit 14 switches between the first circuit element sub-group 121 and the second circuit element sub-group 122.

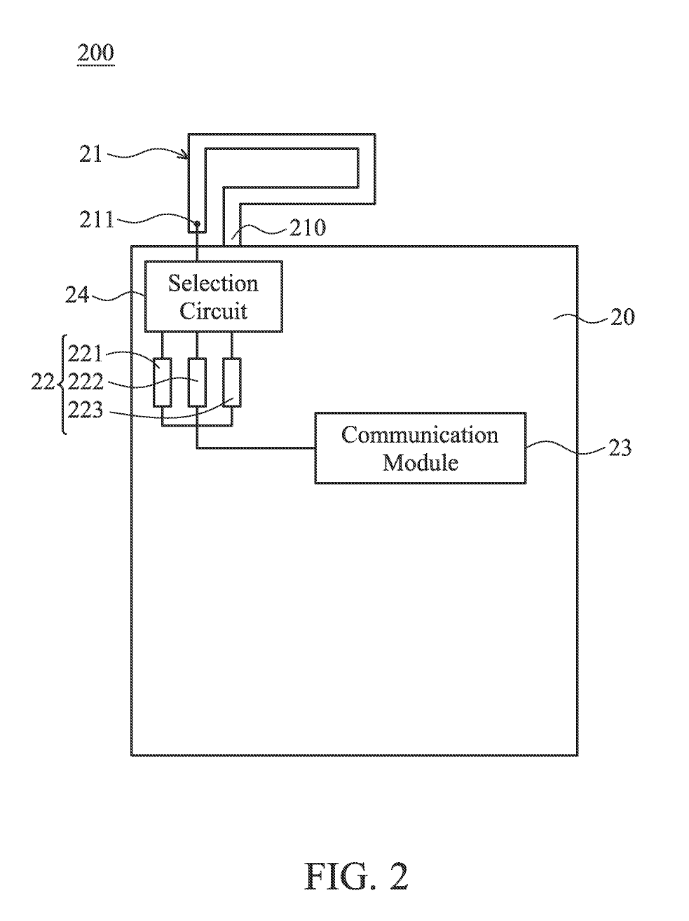

FIG. 2 is a diagram for illustrating a communication device 200 according to a second embodiment of the invention. As shown in FIG. 2, an antenna element 21 is a loop antenna. One end of the antenna element 21 is a grounding end 210 which is electrically coupled to a ground element 20, and the other end of the antenna element 21 is a feeding end 211 which is close to the grounding end 210. In the embodiment, a circuit element group 22 comprises three different circuit element sub-groups, that is, a first circuit element sub-group 221, a second circuit element sub-group 222, and a third circuit element sub-group 223. Similarly, one of the first circuit element sub-group 221, the second circuit element sub-group 222 and the third circuit element sub-group 223 is electrically coupled through a selection circuit 24 to the feeding end 211 of the antenna element 21 so as to make the antenna element 21 operate in different communication bands. Each of the first circuit element sub-group 221, the second circuit element sub-group 222 and the third circuit element sub-group 223 comprises at least an inductive element and a capacitive element, wherein the inductive element and the capacitive element are electrically coupled in series. In some embodiments, the selection circuit 24 is electrically coupled to one of the first circuit element sub-group 221, the second circuit element sub-group 222 and the third circuit element sub-group 223 according to a user input or a control signal generated by a processor (not shown). Note that the first circuit element sub-group 221, the second circuit element sub-group 222 and the third circuit element sub-group 223 have different capacitances of the capacitive elements and different inductances of the inductive elements. The capacitive elements are configured to adjust a low-frequency band of the antenna element 21, and the inductive elements are configured to adjust a high-frequency band of the antenna element 21. When the feeding end 211 is electrically coupled to the first circuit element sub-group 221, the antenna element 21 operates in a first band and a second band. When the feeding end 211 is electrically coupled to the second circuit element sub-group 222, the antenna element 21 operates in a third band and a fourth band. When the feeding end 211 is electrically coupled to the third circuit element sub-group 223, the antenna element 21 operates in a fifth band and a sixth band. Each of the first band, the second band, the third band, the fourth band, the fifth band and the sixth band covers at least one mobile communication band. In other embodiments, the selection circuit 24 may be electrically coupled between the circuit element group 22 and a communication module 23 instead, and the selection circuit 24 switches between the first circuit element sub-group 221, the second circuit element sub-group 222 and the third circuit element sub-group 223.

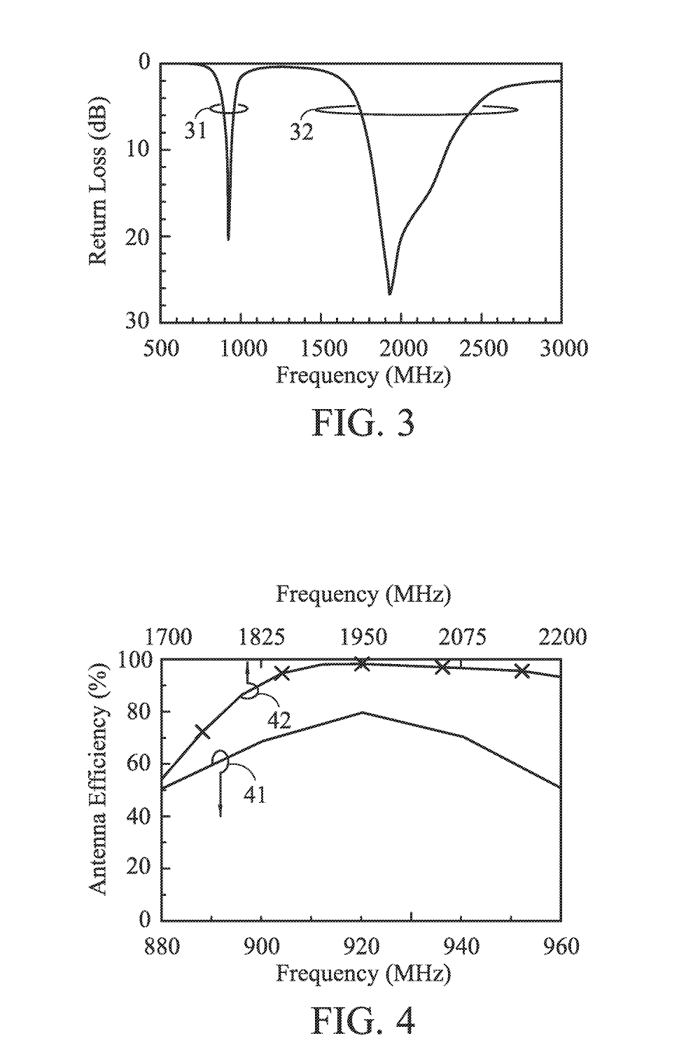

FIG. 3 is a diagram for illustrating return loss when the antenna element 21 is electrically coupled through the selection circuit 24 to the first circuit element sub-group 221 according to the second embodiment of the invention. In response to the capacitance and inductance provided by the first circuit element sub-group 221, the antenna element 21 can obtain optimal impedance matching and operate in the first band 31 and in the second band 32. In the embodiment, the first band 31 and the second band 32 at least cover the GSM900 band and the GSM1800/1900/UMTS bands, respectively.

FIG. 4 is a diagram for illustrating antenna efficiency when the antenna element 21 is electrically coupled through the selection circuit 24 to the first circuit element sub-group 221 according to the second embodiment of the invention. The antenna efficiency curve 41 represents the antenna efficiency of the antenna element 21 which operates in the GSM900 band. The antenna efficiency curve 42 represents the antenna efficiency of the antenna element 21 which operates in the GSM1800/1900/UMTS bands. No matter which band the antenna element 21 operates in, the GSM900 band or the GSM1800/1900/UMTS bands, the communication device 200 of the invention has good antenna efficiency (S parameters included in the antenna efficiency).

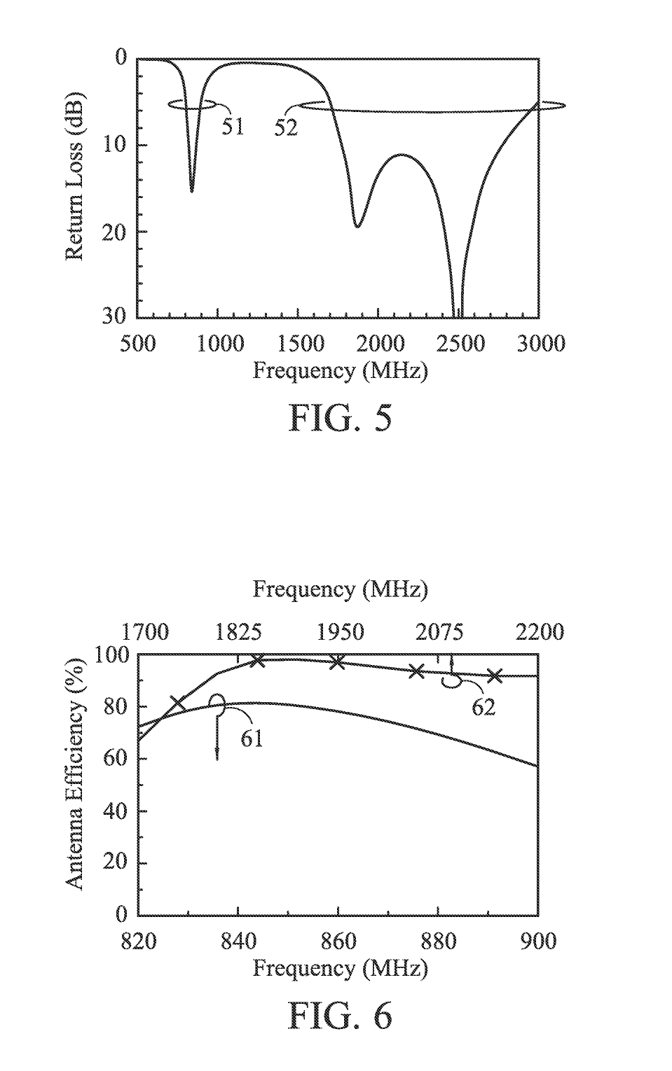

FIG. 5 is a diagram for illustrating return loss when the antenna element 21 is electrically coupled through the selection circuit 24 to the second circuit element sub-group 222 according to the second embodiment of the invention. In response to the capacitance and inductance provided by the second circuit element sub-group 222, the antenna element 21 can obtain optimal impedance matching and operate in the third band 51 and in the fourth band 52. In the embodiment, the third band 51 and the fourth band 52 at least cover the GSM850 band and the GSM1800/1900/UMTS bands, respectively.

FIG. 6 is a diagram for illustrating antenna efficiency when the antenna element 21 is electrically coupled through the selection circuit 24 to the second circuit element sub-group 222 according to the second embodiment of the invention. The antenna efficiency curve 61 represents the antenna efficiency of the antenna element 21 which operates in the GSM850 band. The antenna efficiency curve 62 represents the antenna efficiency of the antenna element 21 which operates in the GSM1800/1900/UMTS bands. No matter which band the antenna element 21 operates in, the GSM850 band or the GSM1800/1900/UMTS bands, the communication device 200 of the invention has good antenna efficiency (S parameters included in the antenna efficiency).

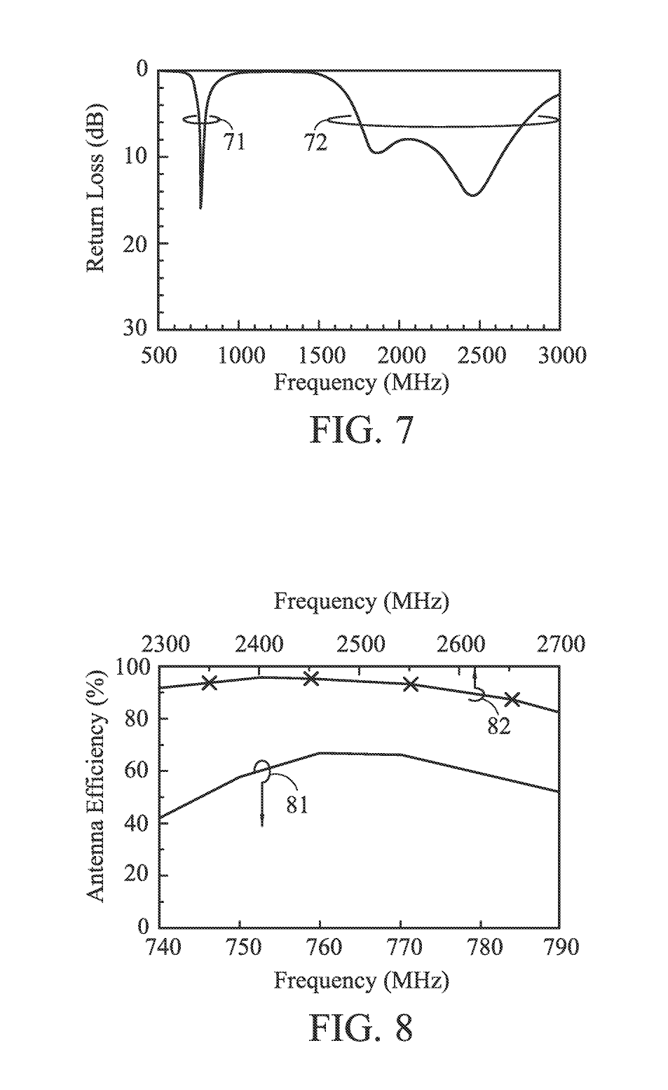

FIG. 7 is a diagram for illustrating return loss when the antenna element 21 is electrically coupled through the selection circuit 24 to the third circuit element sub-group 223 according to the second embodiment of the invention. In response to the capacitance and inductance provided by the third circuit element sub-group 223, the antenna element 21 can obtain optimal impedance matching and operate in the fifth band 71 and in the sixth band 72. In the embodiment, the fifth band 71 and the sixth band 72 at least cover the LTE Band 13 and the LTE2300/2500 bands, respectively.

FIG. 8 is a diagram for illustrating antenna efficiency when the antenna element 21 is electrically coupled through the selection circuit 24 to the third circuit element sub-group 223 according to the second embodiment of the invention. The antenna efficiency curve 81 represents the antenna efficiency of the antenna element 21 which operates in the LTE Band 13. The antenna efficiency curve 82 represents the antenna efficiency of the antenna element 21 which operates in the LTE2300/2500 bands. No matter which band the antenna element 21 operates in, the LTE Band 13 or the LTE2300/2500 bands, the communication device 200 of the invention has good antenna efficiency (S parameters included in the antenna efficiency).

In an embodiment, the antenna element 21 (or 11) of the invention is approximately 23 mm in length and 8 mm in width and 3 mm in height. The total length of the resonant path of the antenna element 21 (or 11) is approximately 62 mm. The small-size antenna element 21 will be easily applied into a variety of communication devices, such as smart phones, and tablet computers.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element;
an antenna element, wherein the antenna element is a loop antenna, one end of the antenna element is a grounding end coupled to the ground element, and the other end of the antenna element is a feeding end close to the grounding end;
a circuit element group comprising at least two separate circuit element sub-groups; and
a communication module coupled to the circuit element group,
wherein one of the circuit element sub-groups of the circuit element group is selectively coupled to the feeding end so as to make the antenna element operate in different communication bands.

2. The communication device as claimed in claim 1, wherein the circuit element group comprises a first circuit element sub-group and a second circuit element sub-group, wherein when the feeding end is coupled to the first circuit element sub-group, the antenna element operates in a first band and a second band, and wherein when the feeding end is coupled to the second circuit element sub-group, the antenna element operates in a third band and a fourth band.

3. The communication device as claimed in claim 2, wherein each of the first band, the second band, the third band and the fourth band covers at least one mobile communication band.

4. The communication device as claimed in claim 2, wherein each of the first circuit element sub-group and the second circuit element sub-group comprises at least an inductive element and a capacitive element, and the inductive element and the capacitive element are coupled in series.

5. The communication device as claimed in claim 1, wherein the circuit element group comprises a first circuit element sub-group, a second circuit element sub-group, and a third circuit element sub-group, wherein when the feeding end is coupled to the first circuit element sub-group, the antenna element operates in a first band and a second band, wherein when the feeding end is coupled to the second circuit element sub-group, the antenna element operates in a third band and a fourth band, and wherein when the feeding end is coupled to the third circuit element sub-group, the antenna element operates in a fifth band and a sixth band.

6. The communication device as claimed in claim 5, wherein each of the first band, the second band, the third band, the fourth band, the fifth band and the sixth band covers at least one mobile communication band.

7. The communication device as claimed in claim 5, wherein each of the first circuit element sub-group, the second circuit element sub-group and the third circuit element sub-group comprises at least an inductive element and a capacitive element, and the inductive element and the capacitive element are coupled in series.

8. The communication device as claimed in claim 1, wherein the antenna element substantially has an inverted L-shape or an L-shape.

9. The communication device as claimed in claim 1, further comprising:
a selection circuit selectively coupling one of the circuit element sub-groups of the circuit element group to the feeding end.

10. The communication device as claimed in claim 9, wherein the selection circuit is coupled between the circuit element group and the antenna element.

11. The communication device as claimed in claim 9, wherein the selection circuit is coupled between the circuit element group and the communication module.
